(19) United States
(12) Patent Application Publication
(10) Pub. No.: US 2023/0081438 A1
(43) Pub. Date: Mar. 16, 2023

(54) Method for Gas Detection Based on Multiple Quantum Neural Networks

(71) Applicant: Chengdu University of Technology, Chengdu (CN)

(72) Inventors: Xingjian Wang, Chengdu (CN); Yajuan Xue, Chengdu (CN); Junxing Cao, Chengdu (CN); Wanping Liao, Chengdu (CN)

(73) Assignee: Chengdu University of Technology, Chengdu City (CN)

(21) Appl. No.: 17/868,148

(22) Filed: Jul. 19, 2022

(30) Foreign Application Priority Data
Aug. 25, 2021 (CN) 202110978872.5

(51) Int. Cl. G01V 1/50; G06N 10/60

(52) U.S. Cl. CPC G01V 1/50; G06N 10/60; G01V 2210/647

(57) ABSTRACT

The present disclosure relates to the field of geophysical processing methods for oil and gas exploration, and more particularly, to a method for gas detection using multiple quantum neural networks. A plurality of stratigraphic and structural seismic attributes are extracted from the seismic data of a target horizon, and input seismic characteristic parameters are divided into different classes by using an unsupervised learning and supervised learning combined quantum self-organizing feature map network. Gas detection is then performed using a particle swarm optimization based quantum gate node neural network with clustering results of various seismic characteristic parameters output by the quantum self-organizing feature map network as inputs. The present method uses the unsupervised learning and supervised learning combined quantum self-organizing feature map network for a plurality of stratigraphic and structural seismic attributes of the seismic data and thus has improved accuracy and uniqueness of clustering.

### CROSS REFERENCE TO RELATED APPLICATION

This patent application claims the benefit and priority of Chinese Patent Application No. 202110978872.5, filed on Aug. 25, 2021, the disclosure of which is incorporated by reference herein in its entirety as part of the present application.

### TECHNICAL FIELD

The present disclosure relates to a geophysical processing method for oil and gas exploration, and more particularly, to a high-accuracy method for gas detection using multiple quantum neural networks.

### BACKGROUND ART

At present, neural networks widely used in geophysical processing methods for oil and gas exploration include a self-organizing feature map network, a back propagation (BP) neural network, etc. The self-organizing feature map network operates in an unsupervised learning manner. Usually, a central node in a competitive layer and nodes in a surrounding neighborhood together represent a mode class, which is generally applicable to seismic facies classification. Seismic stratigraphic parameters having similar reflected wave characteristics may be classified as a same class, but the clustering effect needs to be improved on accuracy and uniqueness. The resulting output results may be directly used in reservoir prediction and gas detection, which, however, are extremely low in accuracy. The BP neural network is widely used in reservoir prediction and gas detection in the field of oil and gas exploration. However, the BP neural network is low in convergence rate and prone to a local minimum during training. Moreover, due to reservoirs of a same fluid type in different sedimentary facies belts having different seismic response characteristics, the direct use of the BP neural network in training the seismic characteristic parameters of a gas-bearing reservoir may easily lead to low accuracy and unsatisfactory effects of reservoir prediction and gas detection.

In recent years, quantum computing has developed greatly. A quantum neural network constructed based on the combination of an artificial neural network and the quantum theory may be helpful to better simulate the information processing of the human brain and improve the approximation capability and the information processing efficiency of the neural network. However, there is no related technology yet at present. Therefore, there is an urgent need for a quantum neural network combined method for gas detection to improve the detection accuracy thereof.

### SUMMARY

To address the above-mentioned problems and to overcome the defects of traditional BP neural network and self-organizing feature map network algorithms, the present disclosure provides a new method and system for high-resolution gas detection using multiple quantum neural networks in combination with seismic attributes based on the existing quantum neural network technology. Thus, the accuracy of gas detection can be improved.

A first objective of the present disclosure is to provide a method for gas detection using multiple quantum neural networks. Specific technical solutions are as follows.

A method for gas detection using multiple quantum neural networks is provided, where unsupervised learning and supervised learning are combined in a quantum self-organizing feature map network; acquired seismic data are input to the quantum self-organizing feature map network that finishes learning for sedimentary facies classification, and classification results are input to a quantum gate node neural network for gas detection.

Further, specific steps may include:
1) calibrating a target horizon of seismic data, and establishing sedimentary facies types with the seismic data, well logging information and comprehensive geological information;
2) extracting seismic attribute parameters from the seismic data of the target horizon, and performing sedimentary facies classification with the seismic attribute parameters using the unsupervised learning and supervised learning combined quantum self-organizing feature map network; and
3) performing gas detection using a particle swarm optimization based quantum gate node neural network with the classification results output by the quantum self-organizing feature map network as inputs.

Specifically, the seismic attribute parameters may include a root mean square amplitude, a waveform variant, a relative wave impedance, a peak amplitude exceeding an average amplitude, an average weighted instantaneous frequency, and a peak frequency.

Specifically, after the seismic attribute parameters are standardized and normalized, seismic facies may be computed using the unsupervised learning and supervised learning combined quantum self-organizing feature map network, and the classification results may be obtained in accordance with the sedimentary facies types in step 1.

Specifically, computing the seismic facies includes unsupervised quantum weight clustering and supervised quantum weight clustering.

Specifically, the unsupervised quantum weight clustering may include:
(1) performing quantum state description on the seismic attribute parameters;
(2) initializing a connection weight vector |Wⱼ> of an input sample |X*> to a competitive layer neuron j;
(3) setting a maxcycle as Max, an initial learning rate as η₀, an initial neighborhood radius as r₀, and a cycle counting tick as s;
(4) calculating No. j* of a competition winner neuron between sample vectors; and
(5) selecting a neighborhood φ(j*,r(s)) having a radius r(s) with j* as the center, and adjusting the weight vector to move toward the sample |X^{m}*>;

if s<Max, s=s+1, and skipping to step (3); otherwise, s=0, skipping to step a) of the supervised quantum weight clustering, the step a) including deriving a class center sample |X*ⱼ> for a vector in a class sample set Mⱼ(j=1,2, . . . , d).

Specifically, the supervised quantum weight clustering may include:
(a) for the vector in the class sample set Mⱼ(j=1,2, . . . , d), deriving the class center sample |X [symbol] [symbol] ;
b) calculating a learning rate η(s);
c) orderly picking out a class set Mⱼ(j=1,2, . . . ,l) from a training set, where l represents the number of mode classes; a winner neuron No. corresponding to the class center sample |X [symbol] [symbol] ; is denoted as dⱼ*, and Dⱼ is defined as a set of competition winner neuron Nos. corresponding to modes in Mⱼ;
d) if s<Max, s=s+1, and skipping to step a); otherwise, saving a weight and finishing network training; and
e) for any sample to be identified, determining a mode class of the sample.

Specifically, step 3) may specifically include:
(a) performing quantum state description on the input classification results;
(b) calculating an output of each layer of the quantum gate node neural network;
(c) calculating an error value of the quantum gate node neural network, performing back propagation calculation of an error, and adjusting parameters of each layer of the network; and
(d) performing gas detection on the seismic data of another region using the trained quantum gate node neural network, and performing inverse normalization on output results to provide gas detection results.

Specifically, the parameters of each layer of the network may be adjusted in the following manner in step (c): performing global parameter optimization by particle swarm optimization and performing local parameter optimization by gradient descent.

A second objective of the present disclosure is to provide a system for gas detection using multiple quantum neural networks. Specific technical solutions are as follows.

A system for gas detection using multiple quantum neural networks includes:

a calibration module configured to calibrate a target horizon of seismic data;

an extraction module configured to extract seismic attribute parameters from the seismic data of the target horizon in the calibration module;

a classification module configured to establish sedimentary facies types with the seismic data, well logging information and comprehensive geological information;

a training module configured to perform sedimentary facies classification using an unsupervised learning and supervised learning combined quantum self-organizing feature map network by combining the seismic attribute parameters in the extraction module with the sedimentary facies types established in the classification module to obtain training samples for training a quantum gate node neural network; and

a detection module configured to perform gas detection on a region using the trained quantum gate node neural network.

Specifically, the seismic attribute parameters may include a root mean square amplitude, a waveform variant, a relative wave impedance, a peak amplitude exceeding an average amplitude, an average weighted instantaneous frequency, and a peak frequency.

Specifically, after the seismic attribute parameters are standardized and normalized by the training module, seismic facies are computed using the unsupervised learning and supervised learning combined quantum self-organizing feature map network, and classification results are obtained in accordance with the sedimentary facies types in the classification module.

Specifically, computing the seismic facies includes unsupervised quantum weight clustering and supervised quantum weight clustering.

The present disclosure has the following beneficial effects:
(1) The unsupervised learning and supervised learning combined quantum self-organizing feature map network is used, which has improved accuracy and uniqueness of clustering as compared with the traditional quantum self-organizing feature map network using unsupervised learning.
(2) The particle swarm optimization based quantum gate node neural network is used, and the problem that the traditional BP neural network is slow in convergence and prone to the local minimum is overcome.
(3) The method for gas detection using multiple quantum neural networks that combines the quantum self-organizing feature map network with the quantum gate node neural network is a phased gas detection method, which is beneficial to effectively identify fluid characteristics in different facies belts and improve the results of gas detection on gas complex lithology reservoirs.
(4) The quantum neural learning algorithm operates fast and is suitable for processing of a large batch of seismic signals.

### BRIEF DESCRIPTION OF THE SEVERAL VIEWS OF THE DRAWINGS

FIG. 1 is a flowchart of gas detection using multiple quantum neural networks.

FIG. 2 is a structure diagram of a quantum gate node neural network used in the present disclosure.

FIG. 3 shows a seismic cross-section of post-stack migration of a gas-bearing carbonate reservoir in Sichuan basin (at a target interval).

FIG. 4 is a diagram showing a transverse gas distribution estimated using the present disclosure (at a target interval).

FIG. 5 is a diagram showing a transverse gas distribution estimated using a traditional BP neutral network (at a target interval).

### DETAILED DESCRIPTION OF THE EMBODIMENTS

The present disclosure will be described in further detail below by way of specific embodiments. It is to be understood that understood that specific embodiments described herein are merely intended to explain rather than limit the present disclosure. It will be appreciated by those skilled in the art that modifications and substitutions may be made to the details and forms of the technical solutions of the present disclosure without departing from the structural idea and the use scope of the present disclosure, but these modifications and substitutions still fall within the protection scope of the present disclosure.

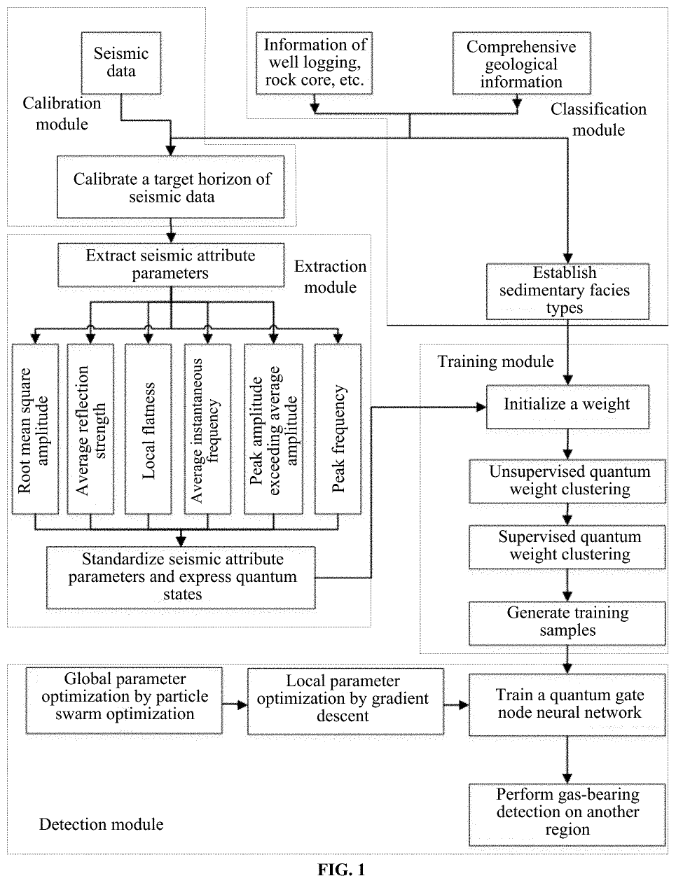

Method for gas detection using multiple quantum neural networks is an adaptive method for high-resolution gas detection. As shown in FIG. 1, the method for gas detection using multiple quantum neural networks includes the following steps:
(1) accurately calibrate a target horizon of seismic data by comprehensively utilizing geological information, well logging information and a synthetic seismogram, and establish sedimentary facies types;
(2) for the seismic data of the target horizon, divide input seismic attribute parameters into different classes by using an unsupervised learning and supervised learning combined quantum self-organizing feature map network, each class corresponding to a different sedimentary facies belt; and
(3) perform gas detection using a particle swarm optimization based quantum gate node neural network with clustering results of various seismic attribute parameters output by the quantum self-organizing feature map network as inputs.

The core problem of the method for gas detection using multiple quantum neural networks provided in the present disclosure is to extract the clustering information of seismic characteristic parameters from the seismic data using the unsupervised learning and supervised learning combined quantum self-organizing feature map network and realize high-accuracy gas bearing detection on a reservoir based on the obtained clustering information of various seismic characteristic parameters in combination with the quantum gate node neural network.

To implement the method described above, an embodiment provides a system for performing the method. Modules shown in FIG. 1 provide a system for gas detection using multiple quantum neural networks, including:
a calibration module configured to calibrate a target horizon of seismic data;
an extraction module configured to extract seismic attribute parameters from the seismic data of the target horizon in the calibration module;
a classification module configured to establish sedimentary facies types with the seismic data, well logging information and comprehensive geological information;
a training module configured to perform sedimentary facies classification using an unsupervised learning and supervised learning combined quantum self-organizing feature map network by combining the seismic attribute parameters in the extraction module with the sedimentary facies types established in the classification module to obtain training samples for training a quantum gate node neural network; and
a detection module configured to perform gas detection on a region using the trained quantum gate node neural network.

Specifically, the seismic attribute parameters include a root mean square amplitude, a waveform variant, a relative wave impedance, a peak amplitude exceeding an average amplitude, an average weighted instantaneous frequency, and a peak frequency.

Specifically, after the seismic attribute parameters are standardized and normalized by the training module, seismic facies are computed using the unsupervised learning and supervised learning combined quantum self-organizing feature map network, and classification results are obtained in accordance with the sedimentary facies types in the classification module.

Specifically, computing the seismic facies includes unsupervised quantum weight clustering and supervised quantum weight clustering.

The present disclosure is implemented according to the following specific principles.

1. A target horizon of seismic data is accurately calibrated by comprehensively utilizing geological information, well logging information and a synthetic seismogram, and sedimentary facies types are established.

2. For the seismic data of the target horizon, input seismic characteristic parameters are divided into different classes by using an unsupervised learning and supervised learning combined quantum self-organizing feature map network, where each class corresponds to a different sedimentary facies belt.

2.1. Stratigraphic and structural seismic attributes are extracted from the seismic data of the target horizon. The seismic attribute parameters include a root mean square amplitude, a waveform variant, a relative wave impedance, a peak amplitude exceeding an average amplitude, an average weighted instantaneous frequency, and a peak frequency.

2.2. The extracted seismic attribute parameters X=(x₁, x₂, x₃, x₄, x₅, x₆) are standardized to eliminate dimensional differences. The parameters are standardized according to the following equation:

$${X}_{ik}^{*} = \frac{{x}_{ik} - min ( {x}_{ik} )}{max ( {x}_{ik} ) - min ( {x}_{ik} )} \qquad ( 1 )$$

where X*_{i,j} represents the normalized ith seismic attribute, i=1˜6; min(⋅) represents a minimizing operation; max(⋅) represents a maximizing operation; and the number of sampling points for each attribute is: k=1, 2, . . . , N with N being the length of the sampling points. The normalized seismic attribute parameters are denoted as X*=(x₁*, x₂*, x₃*, x₄*, x₅*, x₆*)

2.3. The seismic facies are computed using the unsupervised learning and supervised learning combined quantum self-organizing feature map network, specifically by the following process:

### 2.3.1 Unsupervised Quantum Weight Clustering

(1) Quantum state description is performed on the normalized seismic attribute parameters X*. Quantum states of the seismic attribute parameters X*=(x₁*, x₂*, x₃*, x₄*, x₅*, x₆*) are defined as:

|X* [symbol] =[|x₁* [symbol] ,|x₂* [symbol] ,|x₃* [symbol] ,|x₄* [symbol] ,|x₅* [symbol] ,|x₆* [symbol] ]^{T} (2),

where

$$\vert {x}_{i}^{*} 〉 = cos ( \frac{2 π}{1 + {e}^{- {x}_{i}^{*}}} ) \vert 0 〉 + sin ( \frac{2 π}{1 + {e}^{- {x}_{i}^{*}}} ) \vert 1 〉 ;$$

and T represents a matrix transposition operation.

(2) A connection weight vector |Wⱼ [symbol] of an input sample |X* [symbol] to a competitive layer neuron j is initialized, |Wⱼ [symbol] =[|wⱼ₁ [symbol] ,|wⱼ₂ [symbol] ,|wⱼ₃ [symbol] ,|wⱼ₄ [symbol] ,|wⱼ₅ [symbol] ,|wⱼ₆ [symbol] ]^{T}, |Wⱼᵢ [symbol] =cos(θ)|0 [symbol] +sin(θ)|1 [symbol] , where j=1,2, . . . , N, i=1 to _{6, θ=2}πυ, and υ is a random number in [0,1].

(3) A maxcycle is set as Max, while an initial learning rate as η₀ , an initial neighborhood radius as r₀, and a cycle counting tick as s=0. A learning rate and a neighborhood radius are calculated by the following equations:

η(s)=η₀(1−s/Max) (3),

η(s)=r₀ (1−s/Max) (4).

(4) The No. j* of the competition winner neuron between sample vectors is calculated. A similarity coefficient of the connection weight vector |Wⱼ [symbol] of the input sample |X^{m}* [symbol] to the competitive layer neuron j is expressed as:

$${r}_{j}^{m} = \vert 〈 {X}^{{m}^{*}} \vert {W}_{j} 〉 \vert = \vert {\sum }_{i = 1}^{6} \frac{〈 {x}_{mi}^{*} \vert {w}_{ji} 〉}{\sqrt{〈 {x}_{mi}^{*} \vert {x}_{mi}^{*} 〉 〈 {w}_{ji} \vert {w}_{ji} 〉}} \vert . \qquad ( 5 )$$

The competition winner node having the maximum similarity coefficient is j*=max{rⱼ^{m}}.

(5) A neighborhood Φ(j*,r(s)) having a radius r(s) is selected with j* as the center, and the weight vector is adjusted to move toward the sample |X^{m}* [symbol] . The weight vector is adjusted according to the following equation:

$$\vert {W}_{j} ( s + 1 ) 〉 = \{ \begin{matrix}[ {U}_{j 1} \vert {w}_{j 1} ( s ) 〉 , {U}_{j 2} \vert {w}_{j 2} ( s ) 〉 , … , {U}_{ji} \vert {w}_{ji} ( s ) 〉 ] , j ∈ ϕ ( {j}^{*} , r ( s ) ) \\ \vert {w}_{j} ( s ) 〉 , j ∉ ϕ ( {j}^{*} , r ( s ) )\end{matrix} \qquad ( 6 ) ,$$

$$where$$

$${U}_{ji} = [ \begin{matrix}cos ( α ( s ) ( {θ}_{ji} ) ) - sin ( α ( s ) ( {θ}_{ji} ) ) \\ sin ( α ( s ) ( {θ}_{ji} ) ) cos ( α ( s ) ( {θ}_{ji} ) )\end{matrix} ] , \\ {θ}_{ji} = - sgn ( \vert \begin{matrix}{a}_{{x}_{mi}} & {a}_{{w}_{ji}} \\ {β}_{{x}_{mi}} & {β}_{{w}_{ji}}\end{matrix} \vert ) arccos ( \frac{〈 {x}_{mi}^{*} \vert {w}_{ji} 〉}{\sqrt{〈 {x}_{mi}^{*} \vert {x}_{mi}^{*} 〉 〈 {w}_{ji} \vert {w}_{ji} 〉}} ) ,$$

and aₓ_{ₘᵢ}, βₓ_{ₘᵢ} and a_{w}_{ⱼᵢ}, β_{w}_{ⱼᵢ} are probability amplitudes of |x*ₘᵢ [symbol] and |wⱼᵢ [symbol] , respectively.

(6) If s<Max, s=s+1,and the process proceeds to step 3; otherwise, s=0, and the process proceeds to step (7).

2.3.2 Supervised Quantum Weight Clustering

(7) For a vector in a class sample set Mⱼ(j=1,2, . . . , d), a class center sample |X*ⱼ [symbol] is derived as:

$$\vert {\overline{X}}_{j}^{*} 〉 = \frac{1}{{n}_{j}} {\sum }_{i = 1}^{{n}_{j}} \vert {X}_{i}^{*} 〉 ; \vert {X}_{i}^{*} 〉 ∈ {M}_{j} ; {n}_{j} = ‖ {M}_{j} ‖ , \qquad ( 7 )$$

$$〈 {X}_{j}^{*} \vert {\overline{X}}_{j}^{*} 〉 = {max}_{i ∈ [ 1 , 2 , … , {n}_{j} ]} 〈 {X}_{i}^{*} \vert {\overline{X}}_{j}^{*} 〉 . \qquad ( 8 )$$

(8) The learning rate is calculated by:

η(s)=η₀(1−s/Max) (9).

(9) A class set Mⱼ(j=1, 2, . . . ,l) is picked out orderly from a training set, where l represents the number of mode classes. By denoting the winner neuron No. corresponding to the class center sample |X*ⱼ [symbol] as d*ⱼ and defining Dⱼ as a set of competition winner neuron Nos. corresponding to modes in Mⱼ, a network weight is adjusted according to the following equation:

$$\vert {W}_{i} ( s + 1 ) 〉 = \{ \begin{matrix}{[ {U}_{i 1}^{+} \vert {w}_{i 1} ( s ) 〉 , … , {U}_{in}^{+} \vert {w}_{in} ( s ) 〉 ]}^{T} , i = {d}_{j}^{*} , X ∈ {M}_{j} \\ {[ {U}_{i 1}^{-} \vert {w}_{i 1} ( s ) 〉 , … , {U}_{in}^{-} \vert {w}_{in} ( s ) 〉 ]}^{T} , i \neq {d}_{j}^{*} , i ∈ {D}_{j} , \vert 〈 X \vert {W}_{{d}_{j}^{*}} 〉 - 〈 X \vert {W}_{i} 〉 \vert < θ \\ \vert {w}_{i} ( s ) 〉 , i \neq {d}_{j}^{*} , i ∈ {D}_{j} , \vert 〈 X \vert {W}_{{d}_{j}^{*}} 〉 - 〈 X \vert {W}_{i} 〉 \vert \geq θ\end{matrix} \qquad ( 10 ) ,$$

$$where$$

$${U}_{ik}^{\pm } = [ \begin{matrix}cos ( α ( s ) ( {θ}_{ik}^{\pm } ) ) - sin ( α ( s ) ( {θ}_{ik}^{\pm } ) ) \\ sin ( α ( s ) ( {θ}_{ik}^{\pm } ) ) cos ( α ( s ) ( {θ}_{ik}^{\pm } ) )\end{matrix} ] , {θ}_{ik}^{\pm } = ∓ sgn ( \vert \begin{matrix}{a}_{{x}_{k}} & {a}_{{w}_{ik}} \\ {β}_{{x}_{k}} & {β}_{{w}_{ik}}\end{matrix} \vert ) arccos ( \frac{〈 {x}_{k} \vert {w}_{ik} 〉}{\sqrt{〈 {x}_{k} \vert {x}_{k} 〉 〈 {w}_{ik} \vert {w}_{ik} 〉}} ) ,$$

and aₓ_{ₖ}, βₓ_{ₖ} and a_{w}_{ᵢₖ}, β_{w}_{ᵢₖ} are probability amplitudes of |x*ₖ [symbol] and |wᵢₖ [symbol] , respectively.

(10) If s<Max, s=s+1, and the process proceeds to step 7; otherwise, the weight is saved and the network training is finished.

(11) For any sample X to be identified, a mode class of the sample is determined. For the completion winner neuron node j* of the competitive layer, if j*=d̅,d̅∈{d*₁,d*₂, . . . ,d*ₗ}, X is classified into the mode class of node d̅; and if j*∉{d*₁,d*₂, . . . ,d*₁} the No. of the node closest to the mode j* in {d*₁,d*₂, . . . ,d*ₗ} is obtained as d̅_{j*} by calculation according to the following equation:

$$〈 {W}_{\overline{d}} \vert {W}_{{j}^{*}} 〉 = {max}_{j ∈ \{ {d}_{1}^{*} , {d}_{2}^{*} , … , {d}_{l}^{*} \}} 〈 {W}_{j} \vert {W}_{{j}^{*}} 〉 〈 {W}_{\overline{d}} \vert {W}_{{j}^{*}} 〉 > θ , \qquad ( 11 )$$

where θ is a clustering threshold. In this case, X is classified into the mode class of node d̅_{j*}. If j* ∉{d*₁,d*₂, . . . d*ₗ} and X cannot be classified into any known class according to equation (11), it is classified into an unknown class.

3. Gas detection is performed using a particle swarm optimization based quantum gate node neural network with clustering results of various seismic characteristic parameters output by the quantum self-organizing feature map network as inputs.

3.1. Quantum state description is performed on the input clustering results of various seismic characteristic parameters. The clustering results of various seismic characteristic parameters output by the quantum self-organizing feature map network are denoted as D=(d*₁,d*₂, . . . ,d*ₗ)^{T}, (d*₁∈{aᵢ,bᵢ}), and quantum states thereof are defined as:

$${\vert D 〉 = [ \vert {d}_{1}^{*} 〉 , \vert {d}_{2}^{*} 〉 , … , \vert {d}_{l}^{*} 〉 ]}^{T} , \qquad ( 12 )$$

$$\vert {d}_{i}^{*} 〉 = cos ( \frac{2 π ( {d}_{i}^{*} - {a}_{i} )}{{b}_{i} - {a}_{i}} ) \vert 0 〉 + sin ( \frac{2 π ( {d}_{i}^{*} - {a}_{i} )}{{b}_{i} - {a}_{i}} ) \vert 1 〉 . \qquad ( 13 )$$

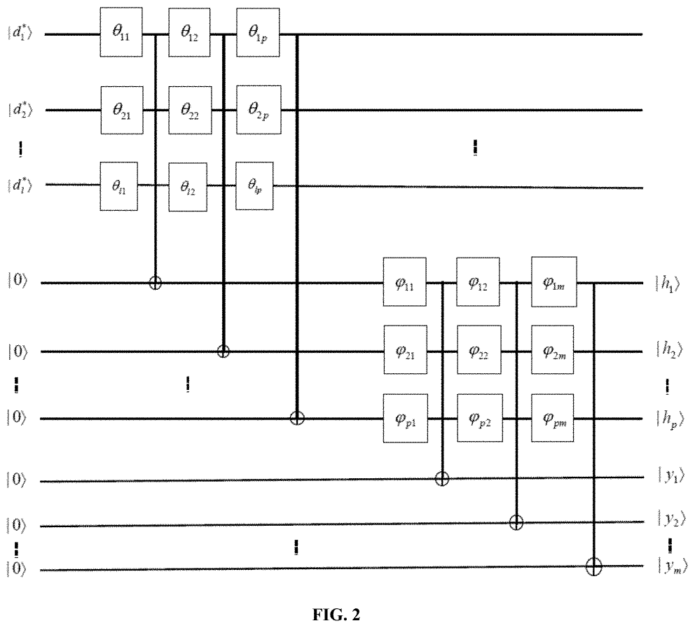

3.2. The output of each layer of the network is calculated. FIG. 2 is a structure diagram of a quantum gate node neural network used in the present disclosure. θ represents a quantum phase-shift gate, and φ represents a quantum controlled NOT gate.

With the probability amplitude of state |1 [symbol] in quantum bits of each layer as the actual output of each layer, the actual output of a hidden layer of the network is expressed as:

$${h}_{j} = sin ( {φ}_{j} ) = {\prod }_{i = 1}^{l} sin ( {θ}_{i} + {θ}_{ij} ) , \qquad ( 14 )$$

and the actual output of an output layer of the network is expressed as:

$${y}_{k} = {\prod }_{j = 1}^{p} sin ( {φ}_{j} + {φ}_{jk} ) = {\prod }_{j = 1}^{p} sin ( arc sin ( {\prod }_{i = 1}^{l} sin ( {θ}_{i} + {θ}_{ij} ) ) + {φ}_{jk} ) \qquad ( 15 ) ,$$

$$where$$

$${φ}_{j} = arc sin ( {\prod }_{i = 1}^{l} sin ( {θ}_{i} + {θ}_{ij} ) ) .$$

3.3. An error value of the neural network is calculated. Back propagation calculation of an error is performed, and parameters of each layer of the network are adjusted.

(1) The error value of the neural network is calculated, and an error function is defined as:

$$E = \frac{1}{2} {\sum }_{k = 1}^{m} {( {\tilde{y}}_{k} - {y}_{k} )}^{2} , \qquad ( 16 )$$

where \tilde{y}ₖ is a desired output.

(2) Global parameter optimization is performed by particle swarm optimization. Since a lot of minimum points exist in the quantum neural network, to improve the search effect, an argument bias matrix θ of the hidden layer of the quantum neural network and an argument bias matrix φ of the output layer of the network are firstly calculated by particle swarm optimization, and the optimization of the parameters of the quantum neural network is performed by global search.

(3) Local parameter optimization is performed by gradient descent. On the basis of global search, the optimal solutions of the argument bias matrix θ of the hidden layer of the quantum neural network and an argument bias matrix φ of the output layer of the network are further calculated by gradient descent. The local search capability is further improved, causing the network error to descend continuously. Rotation angles of different layers are updated according to the following equations:

$${θ}_{ij} ( t + 1 ) = {θ}_{ij} ( t ) - η \frac{\partial E}{\partial {θ}_{ij}} , \qquad ( 17 )$$

$${φ}_{jk} ( t + 1 ) = {φ}_{jk} ( t ) - η \frac{\partial E}{\partial {φ}_{jk}} \qquad ( 18 ) ,$$

$$where$$

$$- \frac{\partial E}{\partial {θ}_{ij}} = {\sum }_{k = 1}^{m} ( {\tilde{y}}_{k} - {y}_{k} ) {y}_{k} cot ( {φ}_{j} + {φ}_{jk} ) {h}_{j} cot ( {θ}_{i} + {θ}_{ij} ) / \sqrt{1 - {h}_{j}^{2}} , \\ {h}_{j} = {\prod }_{i = 1}^{l} sin ( {θ}_{i} + {θ}_{ij} ) , and - \frac{\partial E}{\partial {φ}_{jk}} = ( {\tilde{y}}_{k} - {y}_{k} ) {y}_{k} cot ( {φ}_{j} + {φ}_{jk} ) ;$$

η represents the learning rate, and t represents the number of iterations.

3.4. Gas detection is performed on the seismic data of another region using the trained quantum gate node neural network, and inverse normalization is performed on output results to provide gas detection results.

Comparison of Technical Effects Between the Prior Art and the Present Embodiment

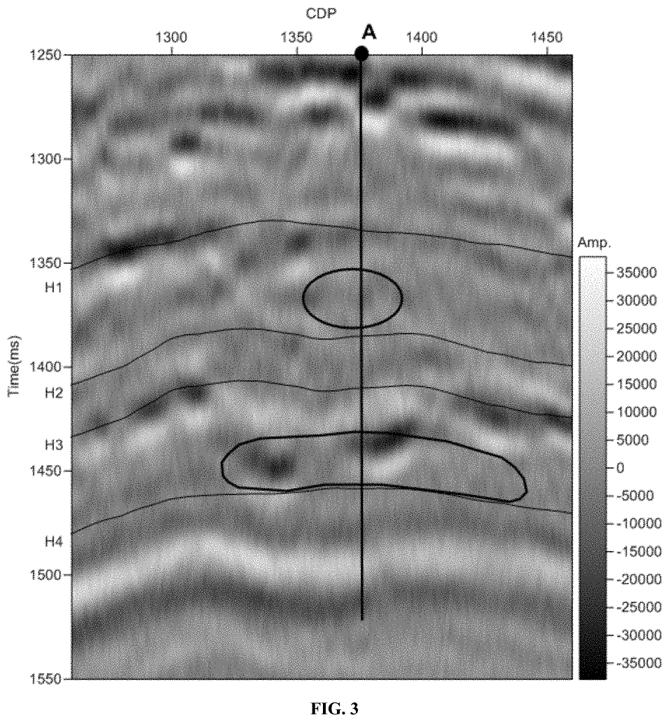

FIG. 3 shows a seismic cross-section of post-stack migration of a gas-bearing carbonate reservoir in Sichuan basin (at a target interval). In the figure, A represents a gas-bearing well. The area shown in the ellipse is a gas-bearing reservoir region. H1, H2, H3, and H4 represent horizons. The gas-bearing reservoir between the H1 and H2 horizons exhibits weak reflection amplitude characteristic, and the gas-bearing reservoir between the H3 and H4 horizons exhibits strong reflection amplitude characteristic.

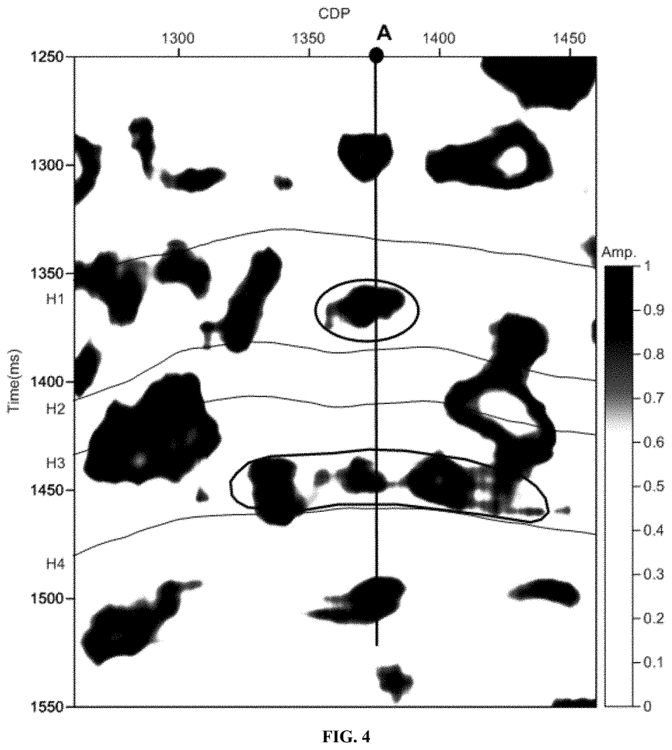

FIG. 4 is a diagram showing a transverse gas distribution of the seismic cross-section estimated using the present disclosure (at the target interval). As shown in the figure, the gas-bearing reservoir exhibiting weak reflection amplitude characteristic between the H1 and H2 horizons has strong energy anomaly characteristic, and the gas-bearing reservoir exhibiting strong reflection amplitude characteristic between the H3 and H4 horizons has strong energy anomaly characteristic. The types of two gas-bearing reservoirs are well detected by the present disclosure, and a gas distribution diagram in conformity with well logging interpretation results is given.

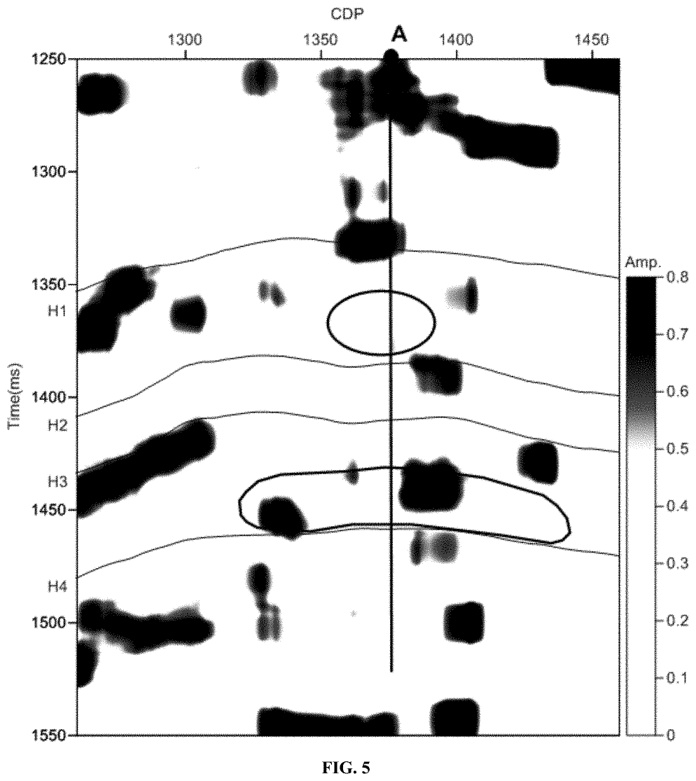

FIG. 5 is a diagram showing a transverse gas distribution estimated using the traditional BP neutral network (at the target interval). As shown in the figure, the gas-bearing reservoir exhibiting weak reflection amplitude characteristic between the H1 and H2 horizons has no strong energy anomaly characteristic, and the gas-bearing reservoir exhibiting strong reflection amplitude characteristic between the H3 and H4 horizons has strong energy anomaly characteristic. Using the traditional BP neutral network, only the gas-bearing reservoir exhibiting strong reflection amplitude characteristic between the H3 and H4 horizons is detected, but the gas-bearing reservoir exhibiting weak reflection amplitude characteristic between the H1 and H2 horizons is not detected. Compared with the present disclosure, the gas-bearing interpretation given by the traditional BP neutral network is not high enough in accuracy.

In conclusion, the method for gas detection using multiple quantum neural networks provided in the present disclosure has the following characteristics:
(1) The unsupervised learning and supervised learning combined quantum self-organizing feature map network is used, which has improved accuracy and uniqueness of clustering as compared with the traditional quantum self-organizing feature map network using unsupervised learning.
(2) The particle swarm optimization based quantum gate node neural network is used, and the problem that the traditional BP neural network is slow in convergence and prone to the local minimum is overcome.
(3) The method for gas detection using multiple quantum neural networks that combines the quantum self-organizing feature map network with the quantum gate node neural network is a phased gas detection method, which is beneficial to effectively identify fluid characteristics in different facies belts and improve the results of gas detection on gas-bearing complex lithology reservoirs.
(4) The quantum neural learning algorithm operates fast and is suitable for processing of a large batch of seismic signals.

The foregoing are merely descriptions of preferred embodiments of the present disclosure, and are not intended to limit the present disclosure. Any modifications, equivalent replacements and improvements made within the spirit and principle of the present disclosure should be included in the protection scope of the present disclosure.

What is claimed is:

1. A method for gas detection using multiple quantum neural networks, wherein unsupervised learning and supervised learning are combined in a quantum self-organizing feature map network; acquired seismic data are input to the quantum self-organizing feature map network that finishes learning for sedimentary facies classification, and classification results are input to a quantum gate node neural network for gas detection.

2. The method according to claim 1, comprising the following specific steps:
1) calibrating a target horizon of seismic data, and establishing sedimentary facies types with the seismic data, well logging information and comprehensive geological information;
2) extracting seismic attribute parameters from the seismic data of the target horizon, and performing sedimentary facies classification with the seismic attribute parameters using the unsupervised learning and supervised learning combined quantum self-organizing feature map network; and
3) performing gas detection using a particle swarm optimization based quantum gate node neural network with the classification results output by the quantum self-organizing feature map network as inputs.

3. The method according to claim 2, wherein the seismic attribute parameters comprise a root mean square amplitude, a waveform variant, a relative wave impedance, a peak amplitude exceeding an average amplitude, an average weighted instantaneous frequency, and a peak frequency.

4. The method according to claim 3, wherein after the seismic attribute parameters are standardized and normalized, seismic facies are computed using the unsupervised learning and supervised learning combined quantum self-organizing feature map network, and the classification results are obtained in accordance with the sedimentary facies types in step 1.

5. The method according to claim 4, wherein computing the seismic facies comprises unsupervised quantum weight clustering and supervised quantum weight clustering.

6. The method according to claim 5, wherein the unsupervised quantum weight clustering comprises:
(1) performing quantum state description on the seismic attribute parameters;
(2) initializing a connection weight vector |Wⱼ> of an input sample |X*> to a competitive layer neuron j;
(3) setting a maxcycle as Max, an initial learning rate as η₀, an initial neighborhood radius as r₀, and a cycle counting tick as s;
(4) calculating No. j* of a competition winner neuron between sample vectors; and
(5) selecting a neighborhood φ(j*,r(s)) having a radius r(s) with j* as the center, and adjusting the weight vector to move toward the sample |X^{m}*>;
if s<Max, s=s+1, and skipping to step (3); otherwise, s=0, skipping to step a) of the supervised quantum weight clustering, the step a) comprising deriving a class center sample |X*ⱼ> for a vector in a class sample set Mⱼ(j=1,2, . . . , d).

7. The method according to claim 5, wherein the supervised quantum weight clustering comprises:
a) for the vector in the class sample set Mⱼ(j=1,2, . . . , d), deriving the class center sample |X [symbol] [symbol] ;
b) calculating a learning rate η(s);
c) orderly picking out a class set Mⱼ(j=1,2, . . . , l) from a training set, wherein l represents the number of mode classes; a winner neuron No. corresponding to the class center sample is denoted as dⱼ*, and Dⱼ is defined as a set of competition winner neuron Nos. corresponding to modes in Mⱼ;
d) if s<Max, s=s+1, and skipping to step a); otherwise, saving a weight and finishing network training; and
e) for any sample to be identified, determining a mode class of the sample.

8. The method according to claim 2, wherein step 3) specifically comprises:
(a) performing quantum state description on the input classification results;
(b) calculating an output of each layer of the quantum gate node neural network;
(c) calculating an error value of the quantum gate node neural network, performing back propagation calculation of an error, and adjusting parameters of each layer of the network; and
(d) performing gas detection on the seismic data of a region using the trained quantum gate node neural network, and performing inverse normalization on output results to provide gas detection results.

9. The method according to claim 8, wherein the parameters of each layer of the network are adjusted in the following manner in step (c): performing global parameter optimization by particle swarm optimization and performing local parameter optimization by gradient descent.

10. A system for gas detection using multiple quantum neural networks, comprising:
a calibration module configured to calibrate a target horizon of seismic data;
an extraction module configured to extract seismic attribute parameters from the seismic data of the target horizon in the calibration module;
a classification module configured to establish sedimentary facies types with the seismic data, well logging information and comprehensive geological information;
a training module configured to perform sedimentary facies classification using an unsupervised learning and supervised learning combined quantum self-organizing feature map network by combining the seismic attribute parameters in the extraction module with the sedimentary facies types established in the classification module to obtain training samples for training a quantum gate node neural network; and
a detection module configured to perform gas detection on a region using the trained quantum gate node neural network.
